(19) United States
(12) Patent Application Publication
(10) Pub. No.: US 2013/0063933 A1
(43) Pub. Date: Mar. 14, 2013

(54) Modular Integrated High Power LED Luminaire

(71) Applicant: Sanjay K. Roy, Palmetto Bay, FL (US)

(72) Inventor: Sanjay K. Roy, Palmetto Bay, FL (US)

(21) Appl. No.: 13/611,888

(22) Filed: Sep. 12, 2012

Related U.S. Application Data
(60) Provisional application No. 61/533,318, filed on Sep. 12, 2011.

(51) Int. Cl. F21V 29/02; F21L 4/02

(52) U.S. Cl. 362/184

(57) ABSTRACT

A a high power luminaire of modular design that is configured such that the thermal management system is integral to its structure. Thus, the basic configuration of the luminaire consists of the LED array attached to the integrated cooling system. Other components and modules that are attached/added to the basic structure include the power/drive module as well as heat transfer enhancement features, air-blowing means, light management components/assemblies and electrical/mechanical fixtures.

### RELATED APPLICATIONS

This Application claims the benefit of U.S. Provisional Application Ser. No. 61/533,318 filed on Sep. 12, 2011, the contents of which are incorporated by reference herein.

### FIELD OF THE INVENTION

This invention is related to the field of luminaires, i.e. electrical lighting assemblies, specifically those that utilize arrays of light emitting diodes (LEDs) as the light generating element.

### BACKGROUND OF THE INVENTION

LEDs are increasingly being used in luminaires due to their higher efficiencies, longer life and increased robustness as compared to other lighting technologies. However, they have specific requirements that can quite different from those associated with these technologies (e.g. incandescent, fluorescent, gas-emission, etc.). A great deal of work has therefore been done on various aspects of LED based luminaires. For example, some lighting quality issues have been covered in U.S. Pat. Nos. 8,002,445, 7,950,832 and 7,988,327, use in incandescent fixtures has been discussed in U.S. patent applications 20100320904 and 20100207534, etc. More systems related issues have been covered in U.S. Pat. Nos. 7,918,591, 7,841,738, 7,800,124, etc., as well as U.S. patent applications 20100226139, 20100208460, etc.

An important systems design issue for LED luminaires is that of temperature control. Unlike incandescent light sources that emit light when the lighting element is at a very high temperature, LEDs must be maintained at low temperatures (preferably near room temperature, typically below 70 C) to ensure long life and proper operation. The problem is complicated by the fact that LEDs are dimensionally very small so that the heat flux (i.e. the heat dissipated per unit area) can become quite large even though the overall heat dissipation is significantly lower than that seen in other comparable lighting technologies. Thus, thermal management is one of the factors in luminaire systems design as can be noted in the systems related patents and applications listed above. Fortunately, this is not very difficult for most (low power) luminaires, and the cooling approaches disclosed in these patents/applications are relatively straightforward.

Unlike the disclosures above, U.S. Pat. No. 7,794,114 and U.S. patent applications 20100302790, 20100226139, 20100148652, 20100118534 and 20080285272 place a greater focus on LED luminaire thermal management. These describe relatively elaborate methods for transferring heat via conduction through spreaders to the luminaire structure and/or housing and then dissipating it to the surroundings through fins. Other related disclosures include U.S. patent applications 20100118496 and 20100091495 that focus on the heat sinks for the LEDs, but not on the overall luminaire. A more complex configuration considering the thermal problem more carefully is U.S. Pat. No. 7,784,971. In this case, a heat pipe is used to absorb heat from the LEDs with the system being configured to then transfer heat from the heat pipe to the luminaire housing.

A review of prior art above shows that LED temperature control is based on relatively simple ad-hoc approaches. Since even heat pipes have relatively limited heat transfer capabilities, it is clear that methods disclosed cannot handle very high luminosity luminaires that have high heat loads/heat fluxes. Fan acoustics related issues that become important for high heat loads have also not been considered in thermal management system design. Cooling system modularity that may help in manufacturing and maintenance are additional issues that have not been considered adequately.

### SUMMARY OF THE INVENTION

The disclosed invention comprises a high power luminaire of modular design with an integrated cooling system. In its preferred embodiment, it incorporates a sealed liquid cooling system for the LED module. The cooling system utilizes a liquid cooled heat sink with the radiator of the cooling system comprising the luminaire housing itself. The LED module is mounted using rapid-mount techniques on the heat sink which preferentially includes an integrated pump. This assembly of the LED module-cooling system forms the basic structure of the luminaire. Lenses/reflectors can be incorporated in the housing as appropriate. The LED electrical drive system consists of a separate module that may be attached to the LED-cooling system assembly. The mechanical design allows for implementation of different types of fixtures, as well as forced air cooling using low speed, low noise fans if necessary. The entire design serves the following goals:

easy assembly/disassembly of the different components, i.e. the LED module, the cooling module and electrical drive module, thereby enhancing manufacturability and serviceability

ability to dissipate very large quantities of heat efficiently, quietly and reliably over extended periods, thereby maintaining the required LED module temperature and increasing the life of the LED module and luminaire

allowing for the implementation of different fixtures without changing the other components of the assembly, thereby reducing system cost and applicability.

### BRIEF DESCRIPTION OF THE DRAWINGS

FIG. 1 is a schematic diagram of the preferred embodiment in a cross-section view. One half section of the figure (the section left of the vertical center line) shows one variation of the preferred embodiment and the second half section (the right section) of the figure shows a second variation of the preferred embodiment.

### DETAILED DESCRIPTION OF THE INVENTION

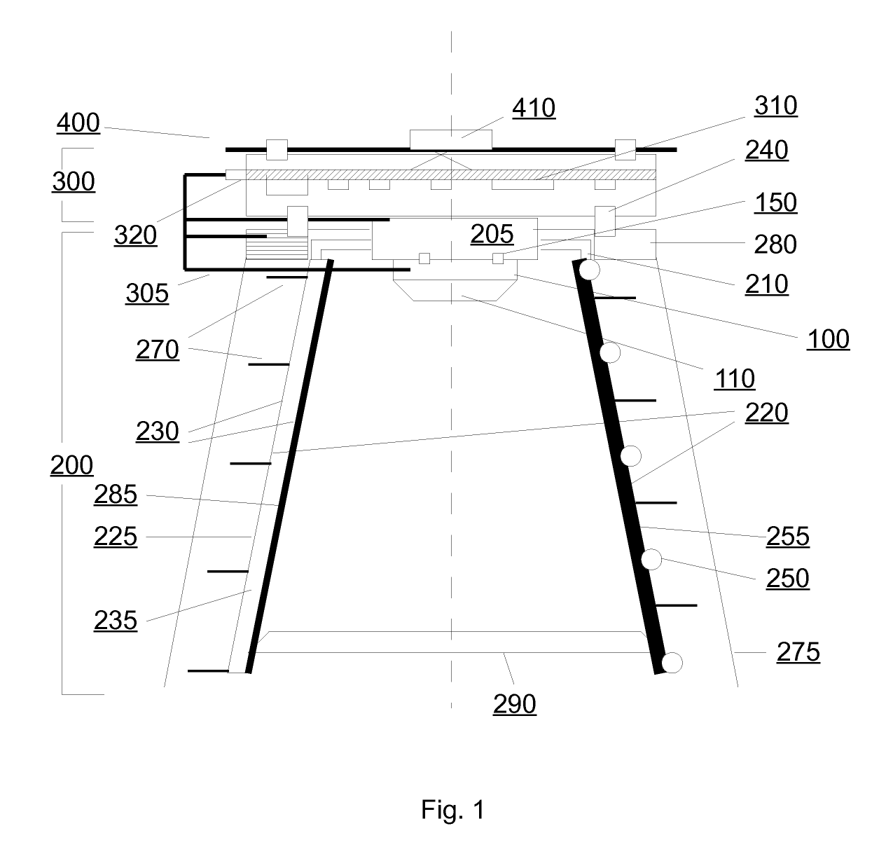

FIG. 1 shows a schematic diagram of the preferred embodiment of the modular luminaire. It is configured such that the thermal management (cooling) system can be integrated into, and function as the luminaire structure. The power management and control functions can be installed as a separate module as can a mechanical/electrical installation subassembly.

The light source is the LED module (100) that comprises an LED array on an integrated heat spreader. Since efficient heat transfer is a primary requirement for a high power luminaire, the base module consists of the cooling system (200) itself to which the other components are attached. The LED module is mounted on the heat absorption section (205). For high power systems, this will typically be a liquid-cooled heat sink that is part of a sealed cooling loop. For designs where the heat dissipations are not as high, this can be the evaporator section of a heat pipe.

To minimize thermal resistance between the LED module (100) and the heat absorption section (205), a thermal interface material such as a thermal grease is used (not shown). Quick assembly/disassembly techniques that permit the application of uniform, constant pressures under varying conditions (clips, pushpins with springs or shoulder screws with springs, etc., all of which are specifically designed for quick attachment, e.g. U.S. Pat. Nos. 6,061,240, 6,118,661, 5,757,621) are used for mechanical attachment (150). This results in good thermal contact at the interface, thereby ensuring good reliability and thermal performance. It also allows for easy installation/removal of the LED module thereby enhancing the overall manufacturability and serviceability of the assembly.

In addition to the heat sink, the liquid cooling system includes a pumping mechanism and fluid connections (210) leading the heat dissipation region (220). The pumping mechanism/pump may be a separate module; however, it is preferentially integrated with the heat sink (205) (e.g. U.S. Pat. No. 6,408,937) or alternatively with the heat dissipation region (e.g. U.S. Pat. No. 7,509,999).

The heat dissipation region (220) is designed such that it performs dual tasks. From a thermal perspective, it performs the task of a radiator, dissipating heat by convection and radiation to the ambient air (like many radiators, it can also provide some excess/storage volume to account for liquid volumetric changes with time and temperature). At the same time, it also functions as the housing structure of the luminaire. This can be accomplished by a variety of configurations, for example:

As shown on the left section of FIG. 1, the radiator/housing can comprise of a shell structure (225) with double walls (230) that forms an enclosure (235). The inlet and outlet conduits (210) of the integrated heat sink/pump (205) are connected to this enclosure thereby creating a closed cooling loop. The inlet and outlet conduits can be designed to be load-bearing so that the entire structure constitutes a single structural assembly. Alternately, the shell structure can be have separate load bearing members (240) attached to the integrated heat sink/pump as required.

A second variation of the preferred embodiment is shown on the right section of FIG. 1. The heat dissipation region can comprise of a continuous tubular coiled structure (250) that is attached to a thermally conductive supporting shell structure (255), with the overall configuration being equivalent to a radiator. Note that the supporting structure provides the additional surface area for heat transfer as required of a radiator. As before, the basic structural assembly can be designed so that mechanical loads are transferred via the inlet/outlet conduits and/or separate structural members attached between the radiator and the heat sink/pump.

There are some lighting situations where the radiator structure can be positioned above the heat absorption section (i.e. when the luminaire faces upwards relative to gravity). For these applications, a mechanical pump may be eliminated for lower powered luminaires, since the liquid cooling system can operate by natural convection, i.e. the temperature differences will constitute the pumping means for the liquid.

Since the surface area requirements can become very large when heat dissipations are high, surface enhancements can be used on the liquid cooling radiator structure or the heat pipe condenser structure (270). Though FIG. 1 shows a “horizontal” fin configuration, alternative geometries, e.g. inclined and/or spiral configurations may be preferred in many cases. Furthermore, the enhancements can be designed such that they not only have large surface areas, but they also provide a decorative function. Heat transfer enhancement features may also be incorporated inside the heat dissipation region of the liquid cooling system (i.e. inside the enclosure (235) or the cooling coil (250)), though this us unlikely to be necessary in most cases.

For higher heat loads, the radiator/surface enhancements can be enclosed in a hollow shroud (275). This can enhance heat transfer via the “chimney effect” whereby air is drawn through the hollow space between the radiator structure and the external shroud. The shroud may be selectively perforated to further enhance flow rates and consequent heat transfer. For very high heat transfer rates, fans (280) may be incorporated so that forced convection heat transfer can be employed. These fans may be attached at either ends of the radiator. Due to the large diameter at the ends of the luminaire, low speed fans can be used, thereby minimizing fan related acoustic noise.

In an alternative embodiment applicable for LEDs with lower heat dissipations, a heat pipe assembly can be used instead of the sealed liquid cooling system. In this approach, the evaporator section of a heat pipe assembly constitutes the heat absorption region to which the LED module is attached. Techniques used for attachment can be similar to those used in the liquid cooling system. The condenser section of the assembly is designed such that it comprises a shell structure similar to the heat dissipation region geometries above.

Select surfaces of the heat dissipating structure can be coated with a light-reflecting material (285) to enhance its lighting performance. Alternatively, light-reflecting films may be attached to these surfaces for the same purpose. Light management optics (e.g. lenses, light-guides) can be also be placed at opening of the housing of the luminaire (290). In this case, seals may be used to further protect the LCD module and the interior of the housing (coatings/films) from the external environment. Note that the LED module itself can also incorporate its own light management optics (110) in the disclosed configuration.

The electrical drive module (300) is detachably mounted on the base module (200) as shown in FIG. 1. It includes all the power conditioning and control circuits and components (310) required to operate the LCD module and the liquid cooling system. Seals, etc. may be used between this module and the base module as appropriate. Power and lighting/cooling system control signals are supplied to the base module from the electrical drive module using detachable electrical connectors (320) via electrical wiring/cables, etc. (305). By utilizing this modular approach, this module can not only be designed separately, but overall luminaire assembly and module replacement is made significantly easier. Improvements in design can be also be introduced into the field more rapidly.

Electrical/mechanical fixtures (410) required for mating the luminaire to an external power source/installation point is incorporated in a final installation module (400) that supplies power to the electrical drive module (300). Alternatively, this can be integrated into the electrical drive module as a separate subassembly. The preferred approach here will depend on the design of the external power source/installation point, i.e. whether these correspond to specific industry or national standards.

While the invention has been described, disclosed, illustrated and shown in various terms or embodiments, the scope of the invention is not intended to be, nor should it be deemed to be, limited thereby, and such other modifications or embodiments as may be suggested by the teachings herein are particularly reserved especially, as they fall within the breadth and scope of the claims here appended.

What is claimed is:

1. A luminaire comprising: an LED module, an integrated cooling system-housing module, and a power and control module,
wherein the said LED module comprises an array of LEDs on an integrated heat spreader,
wherein the said integrated cooling system-housing module comprises a sealed heat transfer loop containing a liquid, with a heat absorption region, a heat dissipation region, multiple fluid connection conduits and a pumping means
wherein the said heat dissipation region comprises a
a double-walled shell structure forming an enclosure,
wherein the said heat absorption unit comprises a liquid cooled heat sink,
wherein the said LED module is detachably attached to said heat absorption region, and
wherein the said conduits are in fluid connection with said heat absorption region and said heat dissipation region,
thereby forming a closed loop,
said liquid being pumped through the said closed loop by the said pumping means, and
wherein the said power and control module are connected to the said LED and said cooling system-housing module and provide power and control for their operation.

2. The luminaire of claim 1, wherein said heat dissipation region comprises a cooling coil conductively attached to a thermally conductive shell structure.

3. The luminaire of claim 1, wherein a quick-disconnect system is used to detachably attach said LED module to heat absorption region.

4. The luminaire of claim 1, wherein the said pumping means is integrated with the said liquid cooled heat sink.

5. The luminaire of claim 1, wherein the said heat dissipation region is positioned above the said heat absorption region, and wherein the said pumping means is temperature differential driven natural convection.

6. The luminaire of claim 1, wherein at least one feature providing enhanced surface area is placed on the external surface of said heat dissipation region.

7. The luminaire of claim 1, wherein at least one heat transfer enhancement feature is placed within one of said hollow enclosure or said cooling coil in said heat dissipation region.

8. The luminaire of claim 1, wherein an external shroud is placed outside said heat dissipation region with an air gap between said shroud and said heat dissipation region.

9. The luminaire of claim 1, wherein an air blowing means is used to force air over the surfaces of said heat dissipation region.

10. The luminaire of claim 1, wherein a surface of said heat dissipation region has a light reflecting coating or light reflecting films attached to it.

11. The luminaire of claim 1, wherein light management optics is attached to the integrated cooling system-housing module.

12. The luminaire of claim 1, wherein said power and control module is detachable from said LED and integrated cooling system-housing modules.

13. The luminaire of claim 1, wherein detachable mechanical and electrical fixtures are attached to said power and control module or integrated cooling system-housing modules

14. A luminaire comprising an LED module, an integrated cooling system-housing module, a heat absorption region, a heat dissipation region, electrical power and a power and control module,
wherein the said LED module comprises an LED array on an integrated heat spreader,
wherein the said integrated cooling system-housing comprises a heat pipe assembly
wherein said heat absorption region comprises an evaporator of said heat pipe assembly,
wherein said heat dissipation region comprises a condenser of said heat pipe assembly,
wherein the said condensor comprises a double-walled shell structure, or a coil conductively attached to a thermally conductive shell structure,
wherein the said LED module is detachably attached to said heat absorption region, and
wherein the said power and control module are connected to the said LED and said cooling system-housing module and provide power and control for their operation.

15. The luminaire of claim 14, wherein a quick-disconnect system is used to detachably attach said LED module to heat absorption region.

16. The luminaire of claim 14, wherein at least one feature providing enhanced surface area is placed on the external surface of said heat dissipation region.

17. The luminaire of claim 14, wherein an external shroud is placed outside said heat dissipation region with an air gap between said shroud and said heat dissipation region.

18. The luminaire of claim 14, wherein an air blowing means is used to force air over the surfaces of said heat dissipation region.

19. The luminaire of claim 14, wherein a surface of said heat dissipation region has a light reflecting coating or light reflecting films attached to it.

20. The luminaire of claim 14, wherein light management optics is attached to the integrated cooling system-housing module.

21. The luminaire of claim 14, wherein said power and control module is detachable from said LED and integrated cooling system-housing modules.

22. The luminaire of claim 14, wherein detachable mechanical and electrical fixtures are attached to said power and control module or integrated cooling system-housing modules
